(19) United States
(12) Patent Application Publication
(10) Pub. No.: US 2025/0055665 A1
(43) Pub. Date: Feb. 13, 2025

(54) USING TIME DIVISION DUPLEXING SYSTEMS IN FREQUENCY DIVISION DUPLEXING NETWORKS

(71) Applicant: VIASAT, INC., Carlsbad, CA (US)

(72) Inventors: Kenneth V. Buer, Bluff City, TN (US); Michail K. Tsatsanis, Huntington Beach, CA (US); Kaushik Chakraborty, Bluff City, TN (US); Sheu Sheu Tan, Encinitas, CA (US); Anton M. Monk, La Jolla, CA (US); Frederick H. Treesh, Carlsbad, CA (US); Donald G. Einig, Norcross, GA (US)

(73) Assignee: VIASAT, INC., Carlsbad, CA (US)

(21) Appl. No.: 18/838,568

(22) PCT Filed: Jan. 6, 2023
(86) PCT No.: PCT/US2023/010356

§ 371 Date: Aug. 14, 2024

Related U.S. Application Data
(60) Provisional application No. 63/297,623, filed on Jan. 7, 2022.

(51) Int. Cl. H04L 5/14; H04L 5/00; H04L 27/26

(52) U.S. Cl. CPC H04L 5/1469; H04L 5/0007; H04L 27/2656

(57) ABSTRACT

Described herein are technologies that coordinate operation of access nodes in a communications system to enable the efficient use of TDD systems (e.g., cellular equipment) in an FDD network (e.g., a satellite network). Two access nodes can be configured with complementary schedules so that the forward link slots of a first access node correspond to the return link slots of a second access node and vice versa. In this arrangement, all time slots of a satellite network are utilized except for a switching time gap. Advantageously, although the cellular equipment implements TDD schemes, coordinated operation of the access nodes allows the satellite network to operate in full duplex and the duration of a switching time gap in the schedules can be made relatively small. That is, the switching time gap is not influenced by the propagation delay of the signal through the satellite network.

### CROSS-REFERENCE TO RELATED APPLICATIONS

This application claims priority to U.S. Prov. App. No. 63/297,623 filed Jan. 7, 2022, and entitled “TDD SYSTEM FOR FDD OVER SATELLITE,” which is expressly incorporated by reference herein in its entirety for all purposes.

### BACKGROUND

### Field

The present disclosure generally relates to communications systems that employ both time division duplexing and frequency division duplexing.

### Description of Related Art

Communications systems may employ a variety of technologies to enable communication between devices on a network. Communications systems can use terrestrial network links, non-terrestrial network links, or a combination of these to deliver information between devices. These network links use duplexing to achieve two-way communication over a communications channel. Two forms of duplexing include time division duplexing (TDD) and frequency division duplexing (FDD). In wireless communications systems, time division duplexing uses a single frequency band or channel for both transmit and receive whereas frequency division duplexing uses different frequency bands or channels to transmit and to receive.

### SUMMARY

In some embodiments, the present disclosure relates to a method for coordinating operation of a base station with a first access node and a second access node. The method includes generating a first TDD schedule in baseband for the first access node, the first TDD schedule including a first plurality of forward link time slots and a first plurality of return link time slots with a switching time gap between the first plurality of forward link time slots and the first plurality of return link time slots. The method also includes mapping the first TDD schedule onto an uplink frequency for the first plurality of forward link time slots and onto a downlink frequency for first plurality of return link time slots. The method also includes generating a second TDD schedule in baseband for the second access node, the second TDD schedule including a second plurality of forward link time slots and a second plurality of return link time slots with the switching time gap between the second plurality of forward link time slots and the second plurality of return link time slots. The method also includes mapping the second TDD schedule onto the uplink frequency for the second plurality of forward link time slots and onto the downlink frequency for the second plurality of return link time slots. The first TDD schedule is complementary to the second TDD schedule such that the first plurality of forward link time slots coincide in time with the second plurality of return link time slots and the first plurality of return link time slots coincide in time with the second plurality of forward link time slots.

In some implementations, the method further includes synchronizing in time the first TDD schedule and the second TDD schedule based on a clock signal. In some implementations, the method further includes transmitting the first TDD schedule to the first access node to configure operation of the first access node; and transmitting the second TDD schedule to the second access node to configure operation of the second access node.

In some implementations, the switching time gap in the first TDD schedule coincides in time with the switching time gap in the second TDD schedule. In some implementations, the switching time gap is shorter than a shortest round trip propagation time between the first access node or the second access node and a user terminal with which the first access node or the second access node communicates. In some implementations, a duration of the switching time gap is independent of a round trip propagation time between the first access node or the second access node and a user terminal with which the first access node or the second access node communicates.

In some implementations, a number of time slots of the first plurality of forward link time slots is different from a number of time slots of the first plurality of return link time slots. In some implementations, the first access node and the second access node have identical carrier frequencies and channel bandwidths. In some implementations, the first access node and the second access node share a radio frequency communication channel. In some implementations, the first access node and the second access node share an antenna.

In some embodiments, the present disclosure relates to a base station of a communications system. The base station includes a first access node; a second access node; a diplexer; an adder configured to generate a transmit signal by combining transmit signals from the first access node with transmit signals from second access node and to send the transmit signal to the diplexer; a splitter configured to split a receive signal from the diplexer into received signals for the first access node and received signals for the second access node, to send the received signals for the first access node to the first access node, and to send the received signals for the second access node to the second access node; a clock configured to generate a clock signal to synchronize the first access node and the second access node; and a configuration module. The configuration module is configured to generate a first TDD schedule in baseband for the first access node, the first TDD schedule including a first plurality of forward link time slots and a first plurality of return link time slots with a switching time gap between the first plurality of forward link time slots and the first plurality of return link time slots; map the first TDD schedule onto an uplink frequency for the first plurality of forward link time slots and onto a downlink frequency for first plurality of return link time slots; generate a second TDD schedule in baseband for the second access node, the second TDD schedule including a second plurality of forward link time slots and a second plurality of return link time slots with the switching time gap between the second plurality of return link time slots and the second plurality of forward link time slots; and map the second TDD schedule onto the uplink frequency for the second plurality of forward link time slots and onto the downlink frequency for the second plurality of return link time slots. The first TDD schedule is complementary to the second TDD schedule such that the first plurality of forward link time slots coincide in time with the second plurality of return link time slots and the first plurality of return link time slots coincide in time with the second plurality of forward link time slots.

In some implementations, the base station further includes an antenna coupled to the diplexer, the antenna configured to communicate with a satellite network. In some implementations, the switching time gap in the first TDD schedule coincides in time with the switching time gap in the second TDD schedule. In some implementations, the switching time gap is shorter than a shortest round trip propagation time between the first access node or the second access node and a user terminal with which the first access node or the second access node communicates. In some implementations, a duration of the switching time gap is independent of a round trip propagation time between the first access node or the second access node and a user terminal with which the first access node or the second access node communicates.

In some implementations, the first access node and the second access node are each half duplex. In some implementations, the first access node and the second access node have identical carrier frequencies and channel bandwidths. In some implementations, the first access node is configured to communicate with a first plurality of user terminals over a satellite network and the second access node is configured to communicate with a second plurality of user terminals over the satellite network.

In some embodiments, the present disclosure relates to a communications system that includes a base station having a first access node, a second access node, an antenna, and a configuration module. The configuration module is configured to generate a first TDD schedule in baseband for the first access node, the first TDD schedule including a first plurality of forward link time slots and a first plurality of return link time slots with a switching time gap between the first plurality of forward link time slots and the first plurality of return link time slots; map the first TDD schedule onto an uplink frequency for the first plurality of forward link time slots and onto a downlink frequency for first plurality of return link time slots; generate a second TDD schedule in baseband for the second access node, the second TDD schedule including a second plurality of forward link time slots and a second plurality of return link time slots with the switching time gap between the second plurality of forward link time slots and the second plurality of return link time slots; and map the second TDD schedule onto the uplink frequency for the second plurality of forward link time slots and onto the downlink frequency for the second plurality of return link time slots. The communications system also includes a satellite network comprising a satellite; and a plurality of user terminals configured to communicate with at least one of the first access node and the second access node of the base station through the satellite network. The first TDD schedule is complementary to the second TDD schedule such that the first plurality of forward link time slots coincide in time with the second plurality of return link time slots and the first plurality of return link time slots coincide in time with the second plurality of forward link time slots.

In some implementations, the first access node is configured to communicate with a first set of user terminals of the plurality of user terminals and the second access node is configured to communicate with a second set of user terminals of the plurality of user terminals. In some implementations, a user terminal of the plurality of user terminals is on a moving platform. In some implementations, a user terminal of the plurality of user terminals is a user device configured to communicate directly with the satellite network.

In some implementations, the satellite network includes a low earth orbit satellite. In some implementations, the satellite network includes a geosynchronous satellite.

In some implementations, individual propagation times between the first access node and individual user terminals of the plurality of user terminals differ. In some implementations, at least one propagation time between the first access node and an individual user terminal of the plurality of user terminals changes over time. In some implementations, a timing advance between forward link time slots and return link time slots in a first user terminal of the plurality of user terminals results in return link time slots and forward link time slots overlapping in the first user terminal. In some implementations, a timing advance between forward link time slots and return link time slots in a first user terminal of the plurality of user terminals is configured to result in the switching time gap.

For purposes of summarizing the disclosure, certain aspects, advantages, and novel features have been described herein. It is to be understood that not necessarily all such advantages may be achieved in accordance with any particular embodiment. Thus, the disclosed embodiments may be carried out in a manner that achieves or optimizes one advantage or group of advantages as taught herein without necessarily achieving other advantages as may be taught or suggested herein.

### BRIEF DESCRIPTION OF THE DRAWINGS

Various embodiments are depicted in the accompanying drawings for illustrative purposes and should in no way be interpreted as limiting the scope of this disclosure. In addition, various features of different disclosed embodiments can be combined to form additional embodiments, which are part of this disclosure.

FIG. 1 illustrates a diagram of an example communications system that uses a satellite network to communicatively couple a plurality of user terminals and a gateway routing device to one another to provide access to a network.

FIG. 2A illustrates an example of a typical TDD scheme in a cellular communications system.

FIG. 2B illustrates a comparison of the allocation of time slots in a terrestrial communications system (e.g., a cellular communications system) with the allocation of time slots in a satellite communications system.

FIG. 2C illustrates an example of a typical FDD scheme in a satellite communications system.

FIG. 2D illustrates an example of a typical cellular communications system modified to operate over a satellite network.

FIG. 3 illustrates an example communications system that includes a base station configured to communicate over a satellite network, the base station including a first access node and a second access node that are configured to operate using complementary TDD schedules.

FIG. 4 illustrates an example base station that includes a configuration module that coordinates operation of two access nodes.

FIG. 5 illustrates a flow chart of an example method of coordinating operation of TDD systems (e.g., half duplex access nodes) in an FDD network (e.g., a satellite network).

FIG. 6 illustrates a block diagram of an example configuration system configured to coordinate operation of a first access node and a second access node.

### DETAILED DESCRIPTION OF SOME EMBODIMENTS

The headings provided herein, if any, are for convenience only and do not necessarily affect the scope or meaning of the claimed subject matter.

### Overview

Certain wireless communications systems, such as cellular networks, use time division duplexing (TDD) for communicating between a base station and user equipment, such as a cellular phone. This means that the same carrier frequency or channel is used for both downlink (DL) and uplink (UL) transmissions. Consequently, in a TDD frame there is typically a series of DL slots and a series of UL slots separated by a gap period to allow the equipment to switch between transmitting (Tx) and receiving (Rx). The duration of the gap period is at least two times the propagation delay resulting from the signal propagating between the base station and the user equipment.

Other wireless communications systems, such as satellite networks, may use frequency division duplexing (FDD) for communicating between a ground station and a user terminal. This means that different carrier frequencies or channels are used for DL signals and UL signals, enabling simultaneous communication of DL and UL signals. This means that unlike TDD systems, an FDD system can transmit DL signals and receive UL signals without requiring a gap period to switch between transmitting and receiving.

By modifying cellular systems to operate in frequency bands used by satellites, cellular equipment and devices can be used to communicate over satellite networks. However, the cellular equipment and associated protocols still utilize TDD schemes to communicate even though the satellite network is capable of using FDD schemes. Consequently, a large number of time slots in each frame remain unused in such a configuration. Furthermore, the Rx and Tx slots on the user equipment side may overlap in time due to the propagation delay over the satellite network, which requires simultaneous Rx and Tx functionality (full duplex) at the user equipment.

Accordingly, to address these and other issues, described herein are technologies that coordinate operation of access nodes in a communications system to enable the use of TDD systems (e.g., cellular equipment) in an FDD network (e.g., a satellite network). Two access nodes can be configured with complementary schedules so that the forward link (FL) time slots of a first access node correspond in time with the return link (RL) time slots of a second access node and the RL time slots of the first access node correspond in time with the FL time slots of the second access node. For each access node, however, the schedule does not include FL time slots that overlap in time with RL time slots so that each access node can implement a TDD scheme. The combination of the complementary schedules is configured to utilize all available time slots of the satellite link (except for a switching time gap) so that the satellite network can efficiently implement an FDD scheme while incorporating TDD systems.

Advantageously, because the transmission of signals utilizes FDD schemes and the satellite network can operate in full duplex, the switching time gap can be made relatively small. In other words, the size of the switching time gap is not influenced by the propagation delay of the signal through the satellite link. Advantageously, because the disclosed communications systems enable the use of FDD schemes by coordinating operation of TDD systems, standard or typical TDD systems (e.g., cellular equipment) can be incorporated into FDD networks (e.g., satellite networks) with little or no modification to the equipment. For example, this may be accomplished by implementing a configuration module that coordinates operation of two or more access nodes in a base station.

### Example Communications Systems

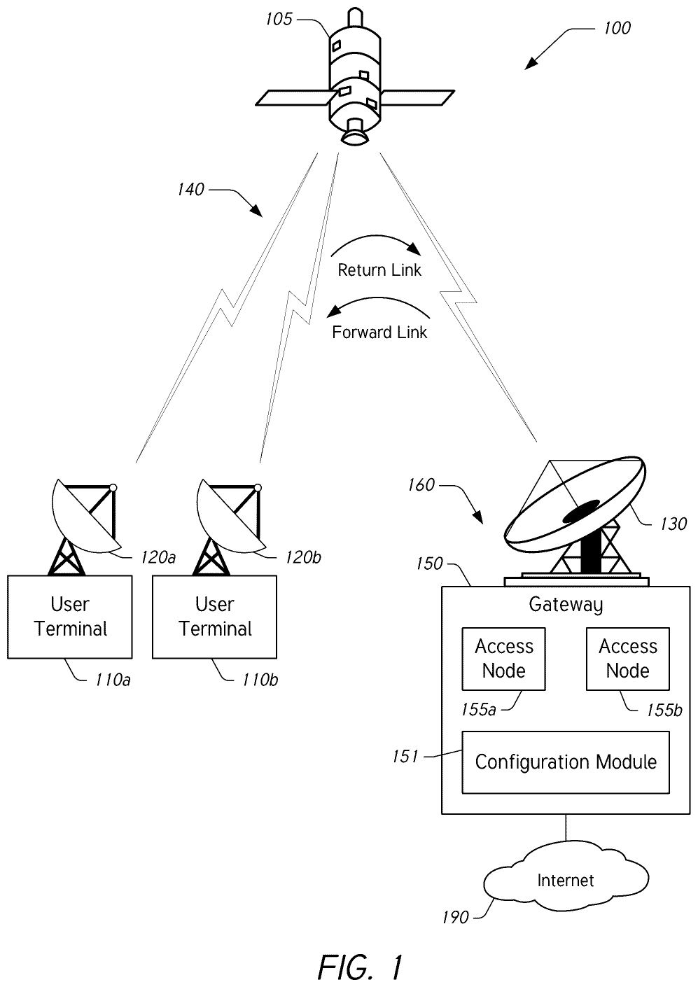

FIG. 1 illustrates a diagram of an example communications system 100 that uses a satellite network 140 to communicatively couple a plurality of user terminals 110a, 110b and a gateway routing device 150 to one another to provide access to a network (such as the Internet 190). The gateway routing device 150 includes a configuration module 151, a first access node 155a, and a second access node 155b. As described in greater detail herein, operation of the first access node 155a and the second access node 155b is coordinated by the configuration module 151 so that the schedules of the access nodes are complementary (e.g., forward link time slots for the first access node 155a correspond to return link time slots for the second access node 155b and vice versa).

The satellite network 140 includes a satellite 105 to provide a satellite link in the communications system 100. Each user terminal 110a, 110b is operatively coupled to a corresponding customer satellite transceiver 120a, 120b that is configured to transmit and receive radio frequency (RF) signals with the satellite 105. In some implementations, the user terminals 110a, 110b and the corresponding customer satellite transceivers 120a, 120b may be integrated together, such as in a handheld terminal or a very small aperture terminal (VSAT) with an integrated antenna (e.g., a parabolic antenna). Similarly, the gateway routing device 150 is operatively coupled to a gateway satellite transceiver 130 that is configured to transmit and receive signals with the satellite 105. The gateway routing device 150 and the gateway satellite transceiver 130 can be integrated into a base station 160, which may also be referred to as a ground station. As described in greater detail herein, the base station 160 can be a base station of a cellular communications system that has been modified to enable communication with the satellite network 140.

The satellite network 140 provides a forward link (FL) for sending information from the gateway routing device 150 to the user terminals 110a, 110b and a return link (RL) for sending information from the user terminals 110a, 110b to the gateway routing device 150. The forward link includes a transmission path from the gateway routing device 150 through the gateway satellite transceiver 130, through the satellite 105 via a satellite uplink (UL) channel, to the customer satellite transceivers 120a, 120b via a satellite downlink (DL) channel, and to the user terminals 110a, 110b. The return link includes a transmission path from the user terminals 110a, 110b through the respective customer satellite transceivers 120a, 120b, through the satellite 105 via the satellite uplink channel, to the gateway satellite transceivers 130 via the satellite downlink channel, and to the gateway routing device 150. It is to be understood that each communication path may utilize multiple satellites and transceivers. The satellite network 140 implements an FDD scheme meaning that the satellite UL channel uses a different frequency band from the satellite DL channel. Thus, the satellite network 140 may be referred to herein as an FDD network.

The gateway routing device 150 includes a configuration module 151 to coordinate operation of the first and second nodes 155a, 155b. In some implementations, the configuration module 151 is a separate component of the communications system 100. In some implementations, part or all of the gateway routing device 150 and/or the configuration module 151 can be located in a virtual device residing in a public or private computing cloud and/or as a part of a distributed computing environment. The configuration module 151 can be configured to coordinate schedules of the access nodes 155a, 155b to enable TDD systems (such as the base station 160) to use an FDD network (such as the satellite network 140).

The configuration module 151 can be configured to perform one or more methods to coordinate operation of two or more access nodes that share the same RF communication channel, such as the first access node 155a and the second access node 155b. Coordination of the access nodes 155a, 155b is accomplished by coordinating the schedules of the first and second access nodes 155a, 155b. The configuration module 151 can be configured to generate a first schedule for the first access node 155a and a second schedule for the second access node 155b, the second schedule being complementary to the first schedule. For example, the configuration module 151 can assign a number of FL time slots and a number of RL time slots separated by a switching time gap to make up the first schedule. To make the second schedule complementary to the first schedule, the configuration module 151 can assign RL time slots in the time slots that correspond to the FL time slots in the first schedule and FL time slots in the time slots that correspond to the RL time slots in the first schedule. Thus, when the first access node 155a is scheduled to receive, the second access node is scheduled to transmit and vice versa. The configuration module 151 can map the first schedule and the second schedule onto the UL and DL frequencies of the satellite network 140. In this way, the available time slots of the satellite network 140 are efficiently utilized. That is, FL or RL time slots that are not utilized by the first access node 155a are utilized by the second access node 155b and vice versa.

In some implementations, the user terminal 110a may or may not be co-located with the user terminal 110b. In some implementations, the user terminal 110a may represent a population of user terminals and the user terminal 110b may represent another population of user terminals and the different populations of user terminals may or may not be co-located. In some implementations, one or more of the user terminals 110a, 110b can be mobile (for example, located on a moving platform or vehicle such as an aircraft, ship, bus, train, etc.). In some implementations, one or more user devices are configured to connect to an individual user terminal. In some implementations, one or both of the user terminals 110a, 110b comprises a user device configured to communicate with the satellite network 140.

The user terminals 110a, 110b can include a router or other user equipment and can be configured to send and receive data routed over the communications system 100. The user terminals 110a, 110b can include or be communicatively coupled to any type of consumer premises equipment (e.g., a telephone, modem, router, computer, set-top box, and the like). The user terminals 110a, 110b are configured to send and receive data using the satellite network 140 via the respective customer satellite transceivers 120a, 120b.

The communications system 100 may utilize various network architectures that include space and ground segments. The satellite network 140 incorporates these elements to provide communications between the plurality of user terminals 110a, 110b and the gateway routing device 150. For example, the space segment may include one or more satellites (such as the satellite 105), while the ground segment may include one or more satellite user terminals (such as the user terminals 110a, 110b), gateway terminals (such as the gateway routing device 150), network operations centers (NOCs), satellite and gateway terminal command centers, ground stations, base stations, and/or the like. Some of these elements are not shown in the figure for the sake of clarity. The satellite network 140 can include a geosynchronous earth orbit (GEO) satellite or satellites, a medium earth orbit (MEO) satellite or satellites, and/or a low earth orbit (LEO) satellite or satellites. It should be understood that the satellite 105 may represent one or more satellites and that the one or more satellites may include GEO satellites, MEO satellites, LEO satellites, or any combination of these.

### Example Duplexing Schemes in Communications Systems

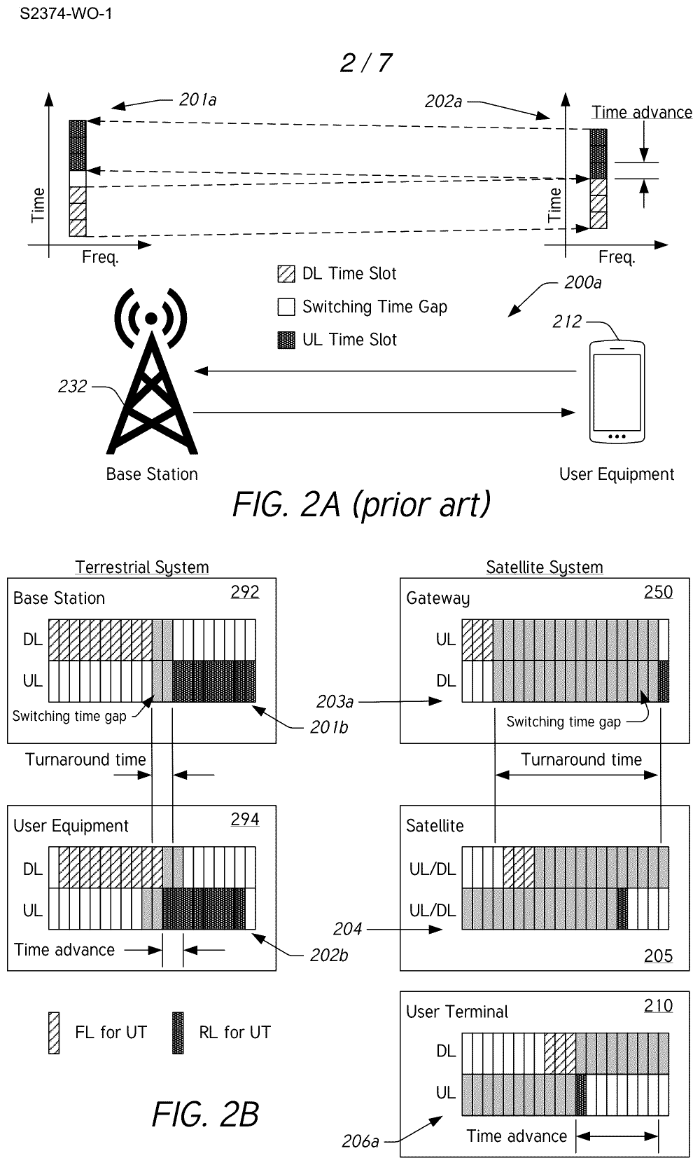

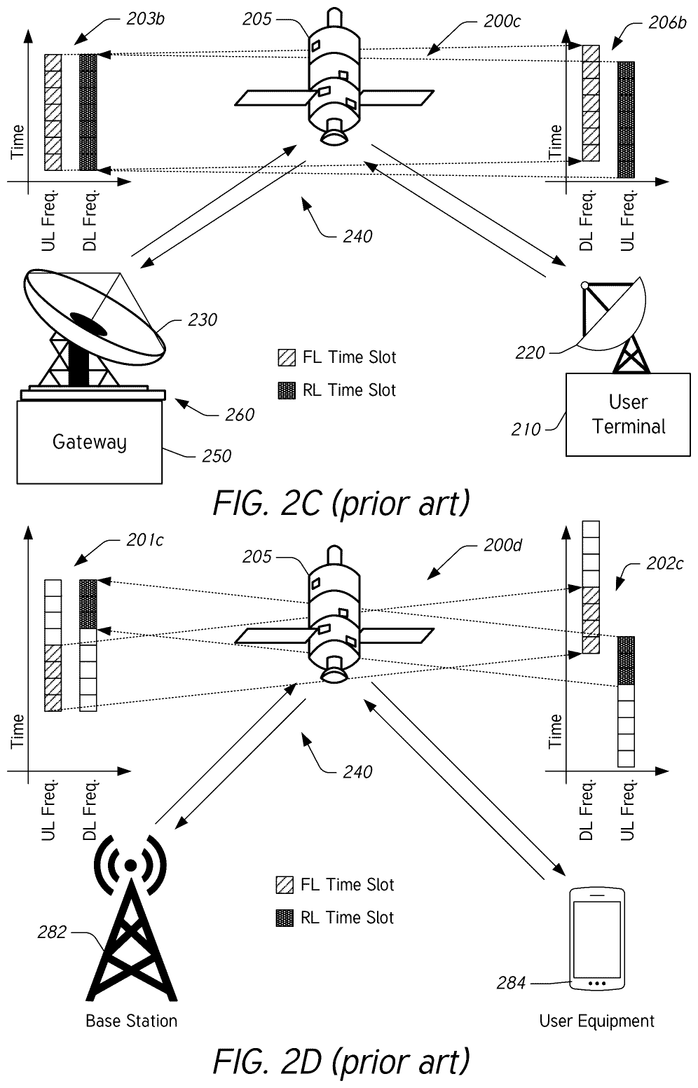

FIGS. 2A, 2B, 2C, and 2D illustrate examples of duplexing schemes and the allocation of time slots in a terrestrial system and in a satellite system. TDD and FDD schemes are illustrated for typical cellular communications systems and for typical satellite communications systems along with time slot allocation in these systems. These time slot allocations demonstrate the effects of propagation delay or round-trip time (RTT) on the schedules for components of the communications systems. In particular, the time slot allocations demonstrate the effect of propagation delay on the size of a switching time gap in TDD schemes and in FDD schemes that utilize TDD equipment.

FIG. 2A illustrates an example of a typical TDD scheme in a cellular communications system 200a. The cellular communications system 200a includes a base station 232 and user equipment 212. The base station 232 and the user equipment 212 are configured to implement a TDD scheme to communicate. This figure illustrates a typical composition of a TDD frame at the base station 232: a series of Tx (DL) time slots followed by a gap period to allow the RF equipment to switch from Tx to Rx (and vice versa), followed by a series of Rx (UL) time slots.

For example, the base station 232 transmits and receives based on a BS schedule 201a. The BS schedule 201a has a plurality of DL time slots and a plurality of UL time slots with a single time slot allocated as a switching time gap between the plurality of DL time slots and the plurality of UL time slots. The switching time gap is configured to allow the RF subsystem to switch between transmitting and receiving. Similarly, the user equipment 212 transmits and receives based on a UE schedule 202a. The UE schedule 202a has a plurality of DL time slots and a plurality of UL time slots that are allocated based on the propagation delay between the base station 232 and the user equipment 212. In addition, to implement the TDD scheme, the UL signals and DL signals are communicated using a single carrier frequency or frequency band.

As can be seen in the UE schedule 202a, the DL time slots are later in time relative to the DL time slots in the BS schedule 201a, the amount of time related to the propagation time or delay. In addition, the UE schedule 202a has a time advance for the UL time slots that is configured so that the UL signals from the user equipment 212 arrives at the base station 232 at a designated time. In other words, there is little or no switching time gap in the UE schedule 202a to reduce or minimize the switching time gap in the BS schedule 201a to reduce or minimize overhead associated with switching between Tx and Rx at the base station 232.

FIG. 2B illustrates a comparison of the allocation of time slots in a terrestrial communications system (e.g., a cellular communications system) with the allocation of time slots in a satellite communications system. This illustrates one of the challenges with implementing a TDD scheme in a satellite communications system: the size of the switching time gap becomes undesirably large due to the relatively long round trip time between the satellite and the ground-based equipment. By way of example, the round-trip time in a LEO satellite communications system may be around 30 milliseconds (ms) and the round-trip time in a GEO satellite communications system may be around 500 ms.

For the terrestrial communications system, a base station 292 (similar to the base station 232 described with reference to FIG. 2A) transmits and receives according to a BS schedule 201b. The BS schedule 201b includes a plurality of time slots allocated for forward link (FL) or DL traffic, followed by a switching time gap, followed by a plurality of time slots allocated for return link (RL) or UL traffic. User equipment 294 (similar to the user equipment 212 described with reference to FIG. 2A) transmits and receives according to a UE schedule 202b. The UE schedule 202b includes a plurality of time slots for FL or DL traffic followed by a plurality of time slots for RL or UL traffic. The propagation delay in this example is about the same duration as a single time slot in the schedules. Thus, the round-trip time is about the size of 2 time slots in the schedules, labeled turnaround time in the figure. Consequently, the UE schedule 202b allocates the beginning of FL traffic 1 time slot after the BS schedule 201b allocates the beginning of FL traffic. Moreover, the UE schedule 202b has a time advance for the RL traffic so that the user equipment 294 is scheduled to transmit RL traffic in a time slot immediately after it is scheduled to finish receiving FL traffic from the base station 292. The propagation delay results in a switching time gap at the base station 292. In this example, the switching time gap is 2 time slots to account for the round-trip time in the terrestrial communications system. In terrestrial communications systems, the turnaround time is relatively small and is part of the system overhead. This means that standard TDD solutions are viable with limited overhead.

In contrast, for the satellite communications system, a gateway 250 (or ground station) transmits and receives according to a GS schedule 203a. The GS schedule 203a includes a plurality of time slots allocated for forward link (FL) or UL traffic, followed by a switching time gap, followed by a time slot allocated for return link (RL) or DL traffic. Satellite 205 (similar to the satellite 105 described with reference to FIG. 1) transmits and receives according to a SAT schedule 204. The SAT schedule 204 includes a plurality of time slots for FL traffic (which includes both UL and DL traffic) followed by a time slot for RL traffic (which includes both UL and DL traffic). The propagation delay from the gateway 250 to the satellite 205 in this example is about the same duration as 3 time slots in the schedules. User terminal 210 (similar to the user terminals 110a, 110b described with reference to FIG. 1) transmits and receives according to a UT schedule 206a. The UT schedule 206a includes a plurality of time slots for FL or DL traffic followed by a time slot for RL or UL traffic. The propagation delay from the satellite 205 to the user terminal 210 in this example is about the same duration as 5 time slots in the schedules. Thus, the total propagation delay from the gateway 250 to the user terminal 210 is about the same duration as 8 time slots in the schedules and the round-trip time is about the size of 16 time slots in the schedules, labeled turnaround time in the figure. In this example, the switching time gap is 16 time slots to account for the round-trip time between the gateway 250 and the user terminal 210. In satellite communications systems, the turnaround time is relatively large (e.g., relative to a terrestrial communications system). This means that standard TDD solutions are undesirable and inefficient because they require a relatively large amount of unused time slots. Consequently, the UT schedule 206a allocates the beginning of FL traffic 8 time slots after the GS schedule 203a allocates the beginning of FL traffic. Moreover, the UT schedule 206a has a time advance for the RL traffic so that the user terminal 210 is scheduled to transmit RL traffic right after it is scheduled to finish receiving FL traffic from the gateway 250. The propagation delay results in a switching time gap at the gateway 250.

It should be noted that although the RL and FL time slots are illustrated as being side-by-side, the above description with reference to FIG. 2B applies to situations where UL and DL frequency bands are the same. The above explanation is particularly relevant to TDD schemes or to situations in which one or more components of a communications system are half duplex such that the equipment is not configured for simultaneously transmitting and receiving.

FIG. 2C illustrates an example of a typical FDD scheme in a satellite communications system 200c. An FDD scheme is used due at least in part to the relatively large latency of the transmission over the satellite link. The switching time gap that would be required in a TDD scheme is excessive and undesirable, as described herein with reference to FIG. 2B, which is at least partially why it is advantageous to implement an FDD scheme in a satellite communications system. The FDD scheme allows the satellite communications system to simultaneously transmit and receive using different frequency bands or carrier frequencies. This figure illustrates a typical composition of an FDD frame at a ground station: a series of FL (UL) time slots in parallel with a series of RL (DL) time slots.

The satellite communications system 200c is similar to the satellite communications system 100 described herein with reference to FIG. 1. The satellite communications system 200c includes the satellite 205 that communications with a ground station 260 (that includes the gateway 250 and a gateway satellite transceiver 230 similar to the gateway satellite transceiver 130) and the user terminal 210 using a customer satellite transceiver 220 (similar to the customer satellite transceivers 120a, 120b) over a satellite network 240.

The ground station 260 transmits and receives according to a GS schedule 203b that includes a plurality of FL time slots allocated in a UL frequency band and a plurality of RL time slots allocated in a DL frequency band. Similarly, the user terminal 210 transmits and receives according to a UT schedule 206b that includes a plurality of FL time slots allocated in the DL frequency band and a plurality of RL time slots allocated in the UL frequency band. The satellite 205 receives the FL traffic from the ground station 260 in the UL frequency band, translates the FL traffic to the DL frequency band, and then transmits the FL traffic to the user terminal 210. Similarly, the satellite 205 receives the RL traffic from the user terminal 210 in the UL frequency band, translates the RL traffic to the DL frequency band, and then transmits the RL traffic to the ground station 260. The FL time slots of the UT schedule 206b are later in time than the corresponding FL time slots of the GS schedule 203b to account for the propagation delay between the ground station 260 and the user terminal 210. Similarly, the RL time slots of the UT schedule 206b are advanced in time relative to the corresponding RL time slots of the GS schedule 203b to account for the propagation delay between the ground station 260 and the user terminal 210. The time advance of the RL time slots of the UT schedule 206b is configured so that the FL and RL time slots in the GS schedule 203b are aligned in time. In some implementations, interference between UL transmissions by the ground station 260 and the user terminal 210 is negligible or not a concern either because different polarizations are used for the different UL transmissions or because the ground station 260 and the user terminal 210 are separated sufficiently geographically.

FIG. 2D illustrates an example of a typical cellular communications system 200d modified to operate over the satellite network 240, the satellite network 240 including the satellite 205. The satellite 205 is capable of full duplex communication (e.g., using an FDD scheme) whereas the base station 282 may operate with half duplex communication (e.g., using a TDD scheme). The user equipment 284 can be configured for full duplex communication to take advantage of the FDD scheme through the satellite 205. In some implementations, the cellular communications system 200d that includes the base station 282 and the user equipment 284 utilizes 5G cellular equipment.

To communicate over the satellite network 240, the RF subsystem of the base station 282 and the RF subsystem of the user equipment 284 can be modified to operate in the satellite frequency bands. Modification of the RF subsystems allows the cellular communications system 200d to use FDD protocols due at least in part to the UL frequency band differing from the DL frequency band. However, because the base station 282 and associated cellular equipment implement a TDD scheme, a large number of time slots remain unused.

For example, the base station 282 transmits and receives according to a BS schedule 201c that includes a plurality of FL time slots allocated in the UL frequency band and a plurality of RL time slots allocated in the DL frequency band. But because the base station 282 operates according to a TDD scheme, the BS schedule 201c allocates the FL time slots, followed by a switching time gap of 1 time slot, followed by the RL time slots, similar to the BS schedule 201a described herein with reference to FIG. 2A. The user equipment 284 transmits and receives according to a UE schedule 202c that includes a plurality of FL time slots allocated in the DL frequency band and a plurality of RL time slots allocated in the UL frequency band. The FL time slots in the UE schedule 202c are later in time than the corresponding FL time slots in the BS schedule 201c due at least in part to the relatively large propagation delay through the satellite network 240. Relatedly, the RL time slots in the UE schedule 202c are allocated earlier in time so that the switching time gap can be reduced or minimized in the BS schedule 201c (e.g., the switching time gap can be 1 time slot between the FL time slots and the RL time slots). This may result in the UE schedule 202c having FL time slots overlap in time with RL time slots, thereby requiring simultaneous transmit and receive capabilities at the user equipment 284.

As a result of the TDD scheme implemented at the base station 282 and the propagation delay over the satellite network 240, there are many unused time slots in both the UL frequency band and the DL frequency band of the base station 282 and the user equipment 284. It would be desirable to utilize these unused time slots to increase efficiency and to utilize the capacity of the satellite network 240 more fully.

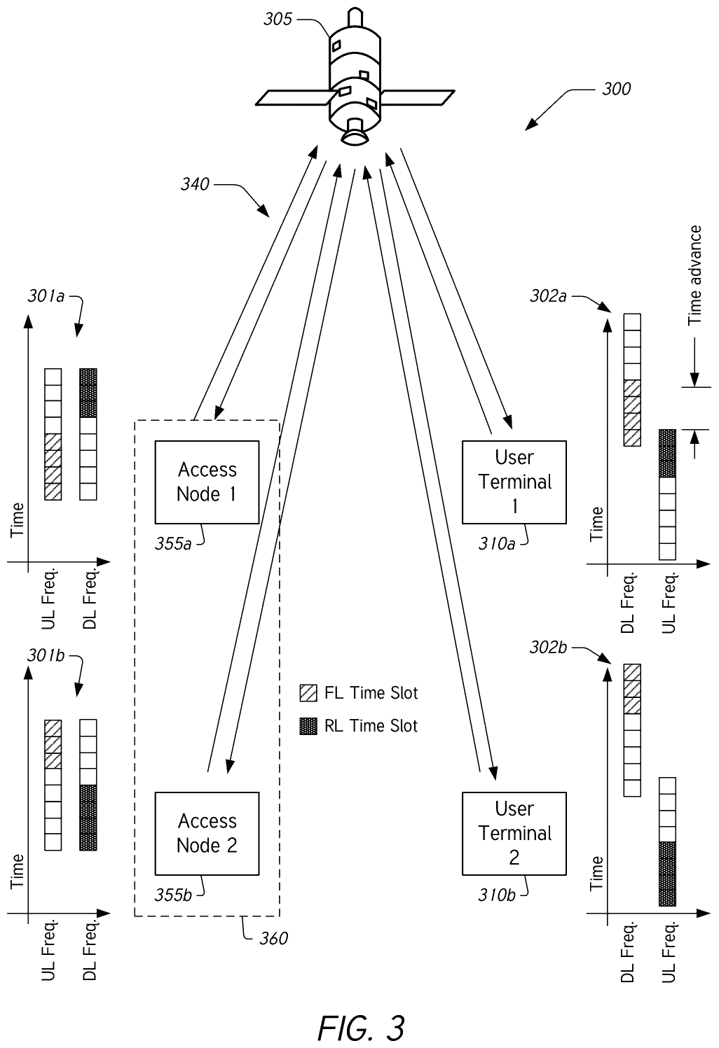

Accordingly, described herein are satellite communications systems with base stations that are modified to include two access nodes with complementary TDD schedules that more fully utilize the capacity of the satellite network by using the time slots that would otherwise be unused in implementations similar to the cellular communications system 200d. FIG. 3 illustrates an example communications system 300 that includes a base station 360 configured to communicate over a satellite network 340, the base station 360 including a first access node 355a and a second access node 355b that are configured to operate using complementary TDD schedules. The communications system 300 also includes a plurality of user terminals 310a, 310b that are configured to communicate over the satellite network 340. The satellite network 340 is similar to the satellite network 140 described herein with reference to FIG. 1 and includes a satellite 305 similar to the satellite 105. Although not illustrated, the base station 360 includes one or more antennas or satellite transceivers as described herein to enable communication with the satellite 305. Similarly, although not illustrated, the user terminals 310a, 310b include antennas or satellite transceivers as described herein to enable communication with the satellite 305. The base station 360 is configured to communicate with the plurality of user terminals 310a, 310b.

The base station 360 includes the first access node 355a that communicates over the satellite network 340 according to a first TDD schedule 301a that includes a plurality of FL time slots and a plurality of RL time slots separated by a switching time gap. The base station 360 includes the second access node 355b that communicates over the satellite network 340 according to a second TDD schedule 301b that includes a plurality of RL time slots and a plurality of FL time slots separated by a switching time gap. The first and second TDD schedules 301a, 301b are referred to as TDD schedules because each access node 355a, 355b implements a TDD scheme wherein the FL time slots and the RL time slots do not overlap. The first and second TDD schedules 301a, 301b are configured to be complementary so that the first TDD schedule 301a includes FL time slots where the second TDD schedule 301b includes RL time slots and the first TDD schedule 301a includes RL time slots where the second TDD schedule 301b includes FL time slots. The schedules are described as complementary because the time slots that are not used in the first TDD schedule 301a are used in the second TDD schedule 301b and vice versa. The first and second TDD schedules 301a, 301b are coordinated so that, in combination, the satellite network 340 operates according to an FDD scheme that uses all available time slots (except for a switching time gap in each TDD schedule). The first and second TDD schedules 301a, 301b can be generated in baseband and then mapped onto the UL and DL frequency bands of the satellite network 340. In some implementations, the first and second TDD schedules have different UL/DL ratios. For example, the UL to DL ratio can be 1:1, 2:3 or 3:2, 3:7 or 7:3, 1:2 or 2:1, etc.

The switching time gap for each of the first and second TDD schedules 301a, 301b are aligned in time and are the same duration. That is, the switching time gap for the first TDD schedule 301a and the switching time gap for the second TDD schedule 301b occupy the same time slots in the frame. The size of the switching time gap can be configured to account for uncertainties in the time of arrival of signals from the user terminals 310a, 310b. However, as described herein, the size of the switching time gap can be independent of and unrelated to the propagation delay through the communications system 300.

The first and second access nodes 355a, 355b each operate in a manner similar to the base station 282 of FIG. 2D. However, to utilize the capacity of the satellite network 340 more fully, the first and second TDD schedules 301a, 301b are coordinated to be complementary, as described herein. The first access node 355a transmits and receives according to the first TDD schedule 301a that includes a plurality of FL time slots followed by a switching time gap followed by a plurality of RL time slots. The second access node 355b transmits and receives according to the second TDD schedule 301b that includes a plurality of RL time slots followed by a switching time gap followed by a plurality of FL time slots. The base station 360 is configured to map the FL time slots of the first and second TDD schedules 301a, 301b to an UL frequency band and to map the RL time slots of the first and second TDD schedules 301a, 301b to a DL frequency band. Consequently, the base station 360 transmits FL traffic and receives RL traffic according to the combination of the first and second TDD schedules 301a, 301b, thereby implementing an FDD scheme over the satellite network 340 that uses all available time slots (except for the switching time gap). That is, the base station 360 is capable of operating in full duplex. As a result, the switching time gap can be made relatively small because the base station 360 can simultaneously transmit and receive. Furthermore, the switching time gap does not need to account for the propagation time between the base station 360 and the user terminals 310a, 310b meaning that the size of the switching time gap is not influenced by the round-trip time of the signal through the satellite network 340. For example, the switching time gap can be less than two times the propagation time and/or less than the round-trip time through the satellite network 340. In some implementations, the propagation delay is different for each user terminal 310a, 310b. In some implementations, the propagation delay for a user terminal 310a, 310b changes over time.

The first and second user terminals 310a, 310b each operate in a manner similar to the user equipment 284 of FIG. 2D. In some implementations, the first access node 355a is configured to communicate with the first user terminal 310a and the second access node 355b is configured to communicate with the second user terminal 310b. As described herein, each user terminal 310a, 310b may represent a plurality or set of user terminals so that the first access node 355a is configured to service a first population of user terminals (represented by the first user terminal 310a) and the second access node 355b is configured to service a second population of user terminals (represented by the second user terminal 310b). Moreover, each user terminal 310a, 310b (or population of user terminals) may or may not be co-located.

The first user terminal 310a transmits and receives according to a first UT schedule 302a that includes a plurality of FL time slots allocated in the DL frequency band and a plurality of RL time slots allocated in the UL frequency band. The FL time slots in the first UT schedule 302a are later in time than the corresponding FL time slots in the first TDD schedule 301a due at least in part to the propagation delay through the satellite network 340. Relatedly, the RL time slots in the first UT schedule 302a are allocated earlier in time so that the switching time gap can be reduced or minimized in the first TDD schedule 301a (e.g., the switching time gap can be 1 time slot between the FL time slots and the RL time slots). This may result in the first UT schedule 302a having FL time slots overlap in time with RL time slots, thereby requiring simultaneous transmit and receive capabilities at the first user terminal 310a.

Similarly, the second user terminal 310b transmits and receives according to a second UT schedule 302b that includes a plurality of FL time slots allocated in the DL frequency band and a plurality of RL time slots allocated in the UL frequency band. The FL time slots in the second UT schedule 302b are later in time than the corresponding FL time slots in the second TDD schedule 301b due at least in part to the propagation delay through the satellite network 340. Relatedly, the RL time slots in the second UT schedule 302b are allocated earlier in time so that the switching time gap can be reduced or minimized in the second TDD schedule 301b (e.g., the switching time gap can be 1 time slot between the FL time slots and the RL time slots). This may result in the second UT schedule 302b having FL time slots overlap in time with RL time slots, thereby requiring simultaneous transmit and receive capabilities at the second user terminal 310b.

The first access node 355a and the second access node 355b can be implemented in hardware or software. In some embodiments, the first access node 355a and the second access node 355b can each be a physical entity, such as a tower, or each can be a virtual entity, such as a software defined radio (SDR). In some implementations, the first and second access nodes 355a, 355b share the same RF communication equipment, such as antennas, decoders, encoders, modulators, demodulators, multiplexers, filters, etc.

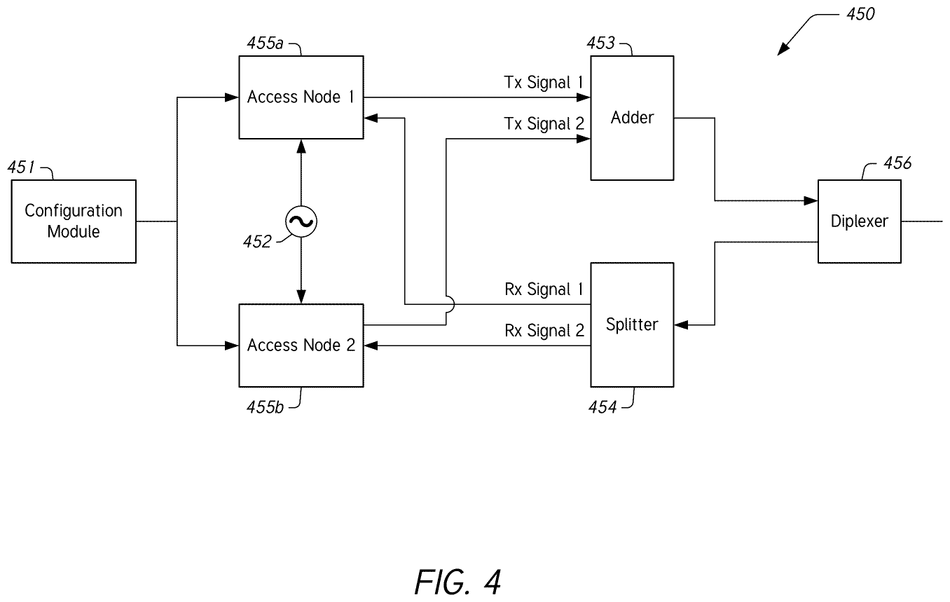

FIG. 4 illustrates an example base station 450 that includes a configuration module 451 that coordinates operation of two access nodes 455a, 455b. The two access nodes 455a, 455b share a common RF subsystem and have coordinated configurations, as described herein. The configuration module 451 can be configured to access computing resources sufficient to implement any method described herein for coordinating operation of the two access nodes 455a, 455b that share the same RF communication channel. In some implementations, the two access nodes 455a, 455b are half duplex and are hooked to the same over the air interface (e.g., the two access nodes 455a, 455b comprise 2 transmitters and 2 receivers that are connected to the same antenna). In some implementations, the configuration module 451 is implemented in a computing device, in a distributed computing environment, in the cloud, etc.

The base station 450 includes two access nodes 455a, 455b and the configuration module 451 with an adder 453, a splitter 454, and a diplexer 456. The two access nodes 455a, 455b are synchronized using the same clock signal 452 to align time slots. Thus, as described herein, the first access node 455a can be assigned a first TDD schedule by the configuration module 451 and the second access node 455b can be assigned a second TDD schedule by the configuration module 451 wherein the first and second TDD schedules are complementary (e.g., the first access node 455a is schedule to transmit while the second access node 455b is scheduled to receive and vice versa). In other words, the allocation of time slots by the configuration module 451 is complementary for the access nodes 455a, 455b.

The base station 450 demonstrates modifications to a standard base station in a typical cellular communications network to implement the technologies described herein. In particular, the base station 450 has a modified RF front end and the base station 450 includes the configuration module 451.

First, the base station incorporates the adder 453 and the splitter 454 to combine the two Tx and Rx signals from the two access nodes 455a, 455b. The adder 453 is configured to generate a transmit signal by combining transmit signals from the first access node 455a with transmit signals from second access node 455b and to send the transmit signal to the diplexer 456. The splitter 454 is configured to split a receive signal from the diplexer 456 into received signals for the first access node and received signals for the second access node, to send the received signals for the first access node to the first access node 455a, and to send the received signals for the second access node to the second access node 455b. The diplexer 456 manages communication of the combined signals between the adder 453 and the splitter 454 and an antenna (not shown). Second, the configuration module 451 jointly configures the parameters of the two access nodes 455a, 455b so that their Tx and Rx time slots are complementary, as described herein. In some implementations, all additional PHY transmission parameters of the two access nodes 455a, 455b are configured to be identical (e.g., carrier frequencies, channel bandwidths etc.).

In addition, the two access nodes 455a, 455b are driven by the same clock signal 452 so that they operate synchronously. The clock signal can be provided from the cloud, through GPS, or using an internal or external clock source. By using the same clock signal 452, the schedules for the two access nodes 455a, 455b can be aligned in time. Furthermore, using the same clock signal 452 can inhibit the schedules from drifting apart (e.g., becoming unsynchronized) over time.

The configuration module 451 is configured to generate a first TDD schedule in baseband for the first access node 455a. The configuration module 451 is further configured to map the first TDD schedule onto UL and DL frequencies of a satellite link or network in which it is implemented. The configuration module 451 is further configured to generate a second TDD schedule in baseband for the second access node 455b, the first and second TDD schedules being complementary. The configuration module 451 is further configured to map the second TDD schedule onto UL and DL frequencies of the satellite link or network in which it is implemented. The result of the complementary TDD schedules may be that each Rx time slot and each Tx time slot for the satellite link is scheduled in either the first TDD schedule or the second TDD schedule so that all Rx and Tx slots of the satellite link are used except for a switching time gap.

### Methods of Coordinating Operation of Two Access Nodes

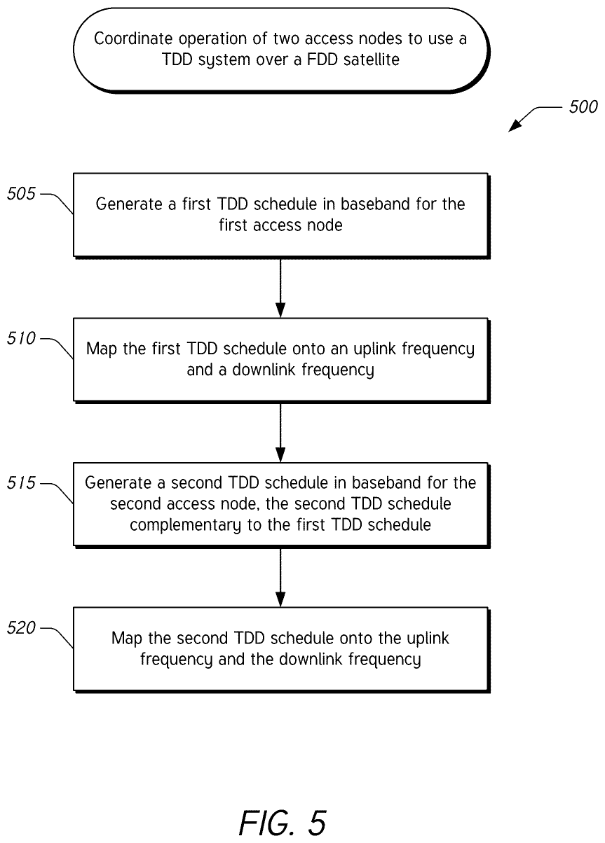

FIG. 5 illustrates a flow chart of an example method 500 of coordinating operation of TDD systems (e.g., half duplex access nodes) in an FDD network (e.g., a satellite network). The method 500 can be performed in any of the base stations or ground stations described herein with reference to FIGS. 1, 3, and 4. For ease of description, the method 500 will be described as being performed by a configuration module. This is not to be understood to limit the scope of the disclosure. Rather, any step or portion of the method 500 can be performed by any component or combination of components of the communications systems described herein.

In block 505, the configuration module generates a first TDD schedule in baseband for the first access node. The first TDD schedule includes a first plurality of forward link time slots and a first plurality of return link time slots with a switching time gap between the first plurality of forward link time slots and the first plurality of return link time slots. In block 510, the configuration module maps the first TDD schedule onto an uplink frequency for the first plurality of forward link time slots and onto a downlink frequency for first plurality of return link time slots.

In block 515, the configuration module generates a second TDD schedule in baseband for the second access node. The second TDD schedule includes a second plurality of return link time slots and a second plurality of forward link time slots with the switching time gap between the second plurality of return link time slots and the second plurality of forward link time slots. In block 520, the configuration module maps the second TDD schedule onto the uplink frequency for the second plurality of forward link time slots and onto the downlink frequency for the second plurality of return link time slots. The first TDD schedule is complementary to the second TDD schedule such that the first plurality of forward link time slots coincide in time with the second plurality of return link time slots and the first plurality of return link time slots coincide in time with the second plurality of forward link time slots.

In some implementations, the configuration module synchronizes in time the first TDD schedule and the second TDD schedule based on a clock signal. In some implementations, the configuration module transmits the first TDD schedule to the first access node to configure operation of the first access node and transmits the second TDD schedule to the second access node to configure operation of the second access node. In some implementations, the number of time slots of the first plurality of forward link time slots is different from the number of time slots of the first plurality of return link time slots.

In some implementations, the switching time gap in the first TDD schedule coincides in time with the switching time gap in the second TDD schedule. The switching time gap can be configured to be shorter than the shortest round trip propagation time between the first access node or the second access node and a user terminal with which the first access node or the second access node communicates. The duration of the switching time gap can be independent of a round trip propagation time between the first access node or the second access node and a user terminal with which the first access node or the second access node communicates.

### Example Configuration Module

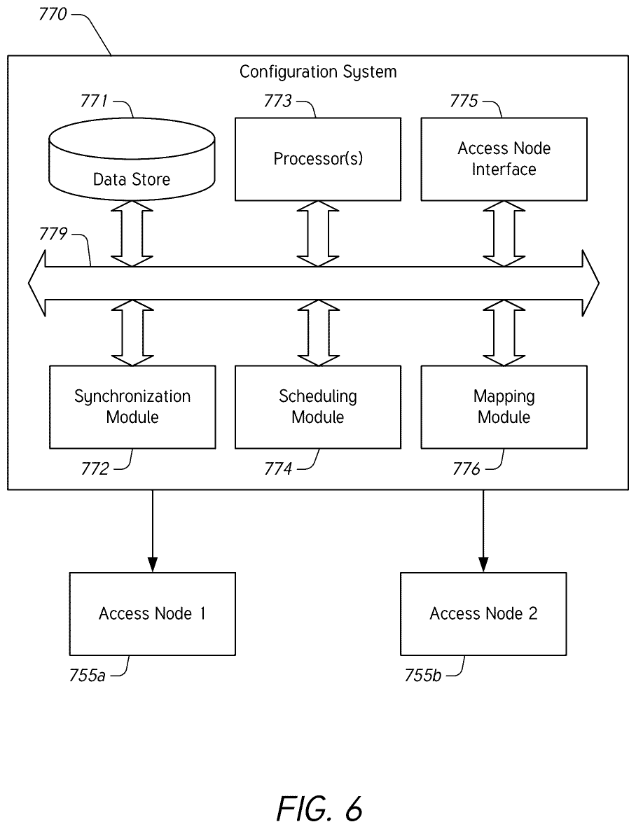

FIG. 6 illustrates a block diagram of an example configuration system 770 configured to coordinate operation of a first access node 755a and a second access node 755b. The configuration system 770 is similar to the configuration module 151 described herein with reference to FIG. 1 and the configuration module 451 described herein with reference to FIG. 4 and can be implemented in any of the communications systems described herein. The configuration system 770 can employ any method described herein for coordinating operation of access nodes with complementary schedules, such as the example method 500 described herein with reference to FIG. 5.

The configuration system 770 can include hardware, software, and/or firmware components for coordinating operation of access nodes in a satellite communications system. The configuration system 770 includes a data store 771, one or more processors 773, an access node interface 775, a synchronization module 772, a scheduling module 774, and a mapping module 776. Components of the configuration system 770 can communicate with one another, with external systems, and with other components of a network using communication bus 779. The configuration system 770 can be implemented using one or more computing devices. For example, the configuration system 770 can be implemented using a single computing device, multiple computing devices, a distributed computing environment, or it can be located in a virtual device residing in a public or private computing cloud. In a distributed computing environment, one or more computing devices can be configured to provide the modules 772, 774, and 776 to provide the described functionality.

The configuration system 770 is configured to communicate with a first access node 755a and a second access node 755b through the access node interface 775. The access nodes 755a, 755b are similar to the access nodes described herein with reference to FIGS. 1, 3, and 4. The configuration system 770 communicates with the access nodes 755a, 755b to coordinate operation of the access nodes 755a, 755b, to synchronize operation of the access nodes 755a, 755b, and/or to communicate schedules to the access nodes 755a, 755b.

The configuration system 770 includes the synchronization module 772 to synchronize operation of the two access nodes 755a, 755b. This can be accomplished using a clock signal that is used for both access nodes 755a, 755b. The clock signal can be provided, for example and without limitation, by an external clock source, GPS, or the cloud. Synchronization allows the time slots of schedules generated for each access node 755a, 755b to be synchronized in time for communication over a satellite network. The configuration system 770 includes the scheduling module 774 to generate TDD schedules for the access nodes 755a, 755b. The scheduling module 774 is configured to determine complementary schedules for the access nodes 755a, 755b, as described herein. The scheduling module 774 is configured to generate the TDD schedules in baseband for the two access nodes 755a, 755b. The configuration system 770 includes the mapping module 776 to map the TDD schedules generated by the scheduling module 774 onto UL and DL frequencies for a satellite network.

The configuration system 770 includes one or more processors 773 that are configured to control operation of the modules 772, 774, 776 and the data store 771. The one or more processors 773 implement and utilize the software modules, hardware components, and/or firmware elements configured to coordinate operation of the access nodes 755a, 755b. The one or more processors 773 can include any suitable computer processors, application-specific integrated circuits (ASICs), field programmable gate array (FPGAs), or other suitable microprocessors. The one or more processors 773 can include other computing components configured to interface with the various modules and data stores of the configuration system 770.

The configuration system 770 includes the data store 771 configured to store configuration data, analysis parameters, control commands, databases, algorithms, executable instructions (e.g., instructions for the one or more processors 773), and the like. The data store 771 can be any suitable data storage device or combination of devices that include, for example and without limitation, random access memory, read-only memory, solid-state disks, hard drives, flash drives, bubble memory, and the like.

### Additional Embodiments and Terminology

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively, or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems and are not limited to the methods and systems described above, and elements and acts of the various embodiments described above can be combined to provide further embodiments. Accordingly, the novel methods and systems described herein may be embodied in a variety of other forms; furthermore, various omissions, substitutions, and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A method for coordinating operation of a base station with a first access node and a second access node, the method comprising:
generating a first TDD schedule for the first access node, the first TDD schedule including a first plurality of forward link time slots and a first plurality of return link time slots with a switching time gap between the first plurality of forward link time slots and the first plurality of return link time slots;
mapping the first TDD schedule onto an uplink frequency for the first plurality of forward link time slots and onto a downlink frequency for first plurality of return link time slots;
generating a second TDD schedule for the second access node, the second TDD schedule including a second plurality of forward link time slots and a second plurality of return link time slots with the switching time gap between the second plurality of forward link time slots and the second plurality of return link time slots; and
mapping the second TDD schedule onto the uplink frequency for the second plurality of forward link time slots and onto the downlink frequency for the second plurality of return link time slots,
wherein the first TDD schedule is complementary to the second TDD schedule such that the first plurality of forward link time slots coincide in time with the second plurality of return link time slots and the first plurality of return link time slots coincide in time with the second plurality of forward link time slots.

2. The method of claim 1 further comprising synchronizing in time the first TDD schedule and the second TDD schedule based on a clock signal.

3. The method of claim 1 further comprising:
transmitting the first TDD schedule to the first access node to configure operation of the first access node; and
transmitting the second TDD schedule to the second access node to configure operation of the second access node.

4. The method of claim 1, wherein the switching time gap in the first TDD schedule coincides in time with the switching time gap in the second TDD schedule.

5. The method of claim 1, wherein the switching time gap is shorter than a shortest round trip propagation time between the first access node or the second access node and a user terminal with which the first access node or the second access node communicates.

6. The method of claim 1, wherein a duration of the switching time gap is independent of a round trip propagation time between the first access node or the second access node and a user terminal with which the first access node or the second access node communicates.

7. The method of claim 1, wherein a number of time slots of the first plurality of forward link time slots is different from a number of time slots of the first plurality of return link time slots.

8. The method of claim 1, wherein the first access node and the second access node have identical carrier frequencies and channel bandwidths.

9. The method of claim 1, wherein the first access node and the second access node share a radio frequency communication channel.

10. The method of claim 1, wherein the first access node and the second access node share an antenna.

11. A base station of a communications system, the base station comprising:
a first access node;
a second access node;
a diplexer;
an adder configured to generate a transmit signal by combining transmit signals from the first access node with transmit signals from second access node and to send the transmit signal to the diplexer;
a splitter configured to split a receive signal from the diplexer into received signals for the first access node and received signals for the second access node, to send the received signals for the first access node to the first access node, and to send the received signals for the second access node to the second access node;
a clock configured to generate a clock signal to synchronize the first access node and the second access node; and
a configuration module configured to:
generate a first TDD schedule for the first access node, the first TDD schedule including a first plurality of forward link time slots and a first plurality of return link time slots with a switching time gap between the first plurality of forward link time slots and the first plurality of return link time slots;
map the first TDD schedule onto an uplink frequency for the first plurality of forward link time slots and onto a downlink frequency for first plurality of return link time slots;
generate a second TDD schedule for the second access node, the second TDD schedule including a second plurality of forward link time slots and a second plurality of return link time slots with the switching time gap between the second plurality of return link time slots and the second plurality of forward link time slots; and
map the second TDD schedule onto the uplink frequency for the second plurality of forward link time slots and onto the downlink frequency for the second plurality of return link time slots,
wherein the first TDD schedule is complementary to the second TDD schedule such that the first plurality of forward link time slots coincide in time with the second plurality of return link time slots and the first plurality of return link time slots coincide in time with the second plurality of forward link time slots.

12. The base station of claim 11 further comprising an antenna coupled to the diplexer, the antenna configured to communicate with a satellite network.

13. The base station of claim 11, wherein the switching time gap in the first TDD schedule coincides in time with the switching time gap in the second TDD schedule.

14. The base station of claim 11, wherein the switching time gap is shorter than a shortest round trip propagation time between the first access node or the second access node and a user terminal with which the first access node or the second access node communicates.

15. The base station of claim 11, wherein a duration of the switching time gap is independent of a round trip propagation time between the first access node or the second access node and a user terminal with which the first access node or the second access node communicates.

16. The base station of claim 11, wherein the first access node and the second access node are each half duplex.

17. The base station of claim 11, wherein the first access node and the second access node have identical carrier frequencies and channel bandwidths.

18. The base station of claim 11, wherein the first access node is configured to communicate with a first plurality of user terminals over a satellite network and the second access node is configured to communicate with a second plurality of user terminals over the satellite network.

19. A communications system comprising:
a base station having a first access node, a second access node, an antenna, and a configuration module configured to:
generate a first TDD schedule for the first access node, the first TDD schedule including a first plurality of forward link time slots and a first plurality of return link time slots with a switching time gap between the first plurality of forward link time slots and the first plurality of return link time slots;
map the first TDD schedule onto an uplink frequency for the first plurality of forward link time slots and onto a downlink frequency for first plurality of return link time slots;
generate a second TDD schedule for the second access node, the second TDD schedule including a second plurality of forward link time slots and a second plurality of return link time slots with the switching time gap between the second plurality of forward link time slots and the second plurality of return link time slots; and
map the second TDD schedule onto the uplink frequency for the second plurality of forward link time slots and onto the downlink frequency for the second plurality of return link time slots;
a satellite network comprising a satellite; and
a plurality of user terminals configured to communicate with at least one of the first access node and the second access node of the base station through the satellite network,
wherein the first TDD schedule is complementary to the second TDD schedule such that the first plurality of forward link time slots coincide in time with the second plurality of return link time slots and the first plurality of return link time slots coincide in time with the second plurality of forward link time slots.

20. The communications system of claim 19, wherein the first access node is configured to communicate with a first set of user terminals of the plurality of user terminals and the second access node is configured to communicate with a second set of user terminals of the plurality of user terminals.

21. The communications system of claim 19, wherein a user terminal of the plurality of user terminals is on a moving platform.

22. The communications system of claim 19, wherein a user terminal of the plurality of user terminals is a user device configured to communicate directly with the satellite network.

23. The communications system of claim 19, wherein the satellite network includes a low earth orbit satellite.

24. The communications system of claim 19, wherein the satellite network includes a geosynchronous satellite.

25. The communications system of claim 19, wherein individual propagation times between the first access node and individual user terminals of the plurality of user terminals differ.

26. The communications system of claim 19, wherein at least one propagation time between the first access node and an individual user terminal of the plurality of user terminals changes over time.

27. The communications system of claim 19, wherein a timing advance between forward link time slots and return link time slots in a first user terminal of the plurality of user terminals results in return link time slots and forward link time slots overlapping in the first user terminal.

28. The communications system of claim 19, wherein a timing advance between forward link time slots and return link time slots in a first user terminal of the plurality of user terminals is configured to result in the switching time gap.
